(19) United States
(12) Patent Application Publication
(10) Pub. No.: US 2015/0271028 A1
(43) Pub. Date: Sep. 24, 2015

(54) PROVIDING SHARED ACCOUNT SERVICE

(71) Applicant: Microsoft Corporation, Redmond, WA (US)

(72) Inventors: Xin Li, Redmond, WA (US); Subash Bhamidipati, Bellevue, WA (US); James O'Brien, Kirkland, WA (US); Jimmy Kan, Redmond, WA (US); Daniela Mauler, Seattle, WA (US); Vidya Kotteri, Redmond, WA (US); Krishna Srinivasan Iyer, Bellevue, WA (US); Victor Urnyshev, Bothell, WA (US)

(73) Assignee: Microsoft Corporation, Redmond, WA (US)

(21) Appl. No.: 14/222,610

(22) Filed: Mar. 22, 2014

(51) Int. Cl. H04L 12/24; G06Q 30/06

(52) U.S. Cl. CPC H04L 41/5006; G06Q 30/0609

(57) ABSTRACT

A shared account service may be provided to consolidate account creation for one or more service providers. A unified UI is provided to receive a description information of one or more accounts of a tenant. A contract is configured with a service provider based on an analysis of the description information received through the unified UI and a capability information of the service provider. The contract is transmitted to the service provider to cause the service provider to create the account.

### BACKGROUND

Modern business solutions not only connect people inside and outside the organization, they also give them context and insight which drives better decisions and boosts productivity. Thus, enhanced business solution platforms drive connections with people, with customers and with business partners across processes, data and the ecosystem in which organizations operate.

Traditional business solutions may target a single workload or entire suites presenting integration challenges as the separate workload solutions rarely come from the same application vendor. The suites naturally deliver integration, but may not support workload-at-a-time implementations. An integrated, efficient business solution aims to enable businesses to operate across locations and countries by standardizing processes, to provide visibility across organizations, and to simplify compliance with regulatory, industry standard, and similar entities.

Modern organizations provide tools to enable users to transform business and private environments. Users interface with tools from variety of solution providers to complete work on a continued basis. Each user faces a potential to interact with a different interface when utilizing one of the tools provided by the solution providers. Separate account management by the user at different solution providers also complicates work processes of the user. Each additional step to create and manage an account at the solution providers disrupts a workflow of the user.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a shared account service. A shared account service may provide a unified user interface (UI) to receive description information of one or more accounts of a tenant. The tenant may be a consumer of one or more applications, services, resources, and similar products of one or more service providers. The shared account service may receive a description information of an account through the unified UI. The unified UI may provide data fields to capture description information to create accounts at multiple service providers such as social networking, messaging, storage, processing, analysis and similar providers. A contract may be configured with a service provider based on the description information. The description information may be processed based on a capability information retrieved from a service provider. The capability information may include resource limitations of the service provider. The contract may be transmitted to the service provider to cause the service provider to create the account.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating a scheme to provide a shared account service, according to embodiments;

FIG. 2 is a component diagram of a shared account service managing account creation for users of a tenant at one or more service providers, according to embodiments;

FIG. 3 illustrates an example shared account service and components, according to embodiments;

FIG. 4 is a simplified networked environment, where a system according to embodiments may be implemented;

FIG. 5 is a block diagram of an example computing operating environment, where embodiments may be implemented; and

FIG. 6 illustrates a logic flow diagram for a process to provide a shared account service, according to embodiments.

### DETAILED DESCRIPTION

As briefly described above, a shared account service may be provided to manage account creation of users of tenant(s) at service provider(s). A description information of an account may be received through a provided unified UI. A contract may be configured with a service provider based on the description information. The description information may be processed based on capability information retrieved from the service provider. The contract may be transmitted to the service provider to cause the service provider to create the account.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to provide a shared account service to manage account creation of account(s) of users of tenant(s) at service provider(s). Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

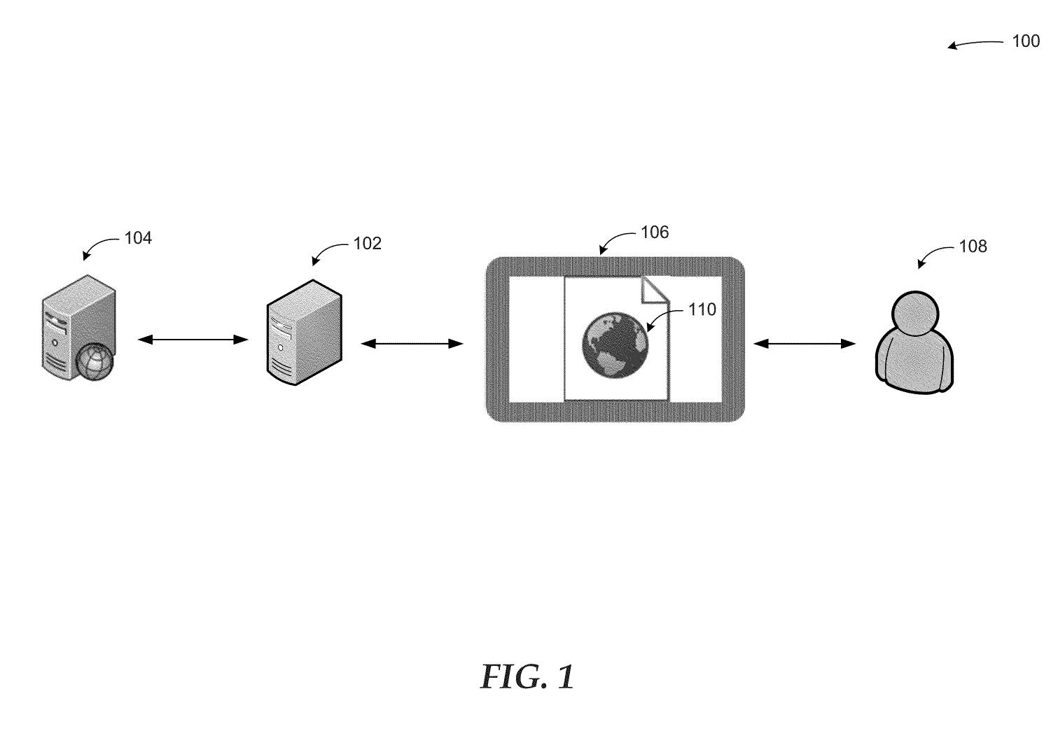

FIG. 1 includes a conceptual diagram 100 illustrating a scheme to provide a shared account service, according to embodiments. A shared account service executing on a server 102 may manage account creation of a user 108 of a tenant at a service provider 104. The service provider may include a social networking provider, a communication service such as an email, messaging, audio or video communication provider, an analysis service that processes data for analytics, a processing provider that allows users to execute applications and services, a storage provider, and similar ones.

The shared account service executing on the server 102 may manage account creation for user(s) of a tenant of the service provider 104. The tenant may consume one or more services provided by the service provider 104. The tenant may be an entity consuming services and resources at the service provider 104 through one or more accounts. The accounts may be associated with users such as the user 108. The users may form the tenant.

Service providers such as the service provider 104 may provide one or more interfaces to allow users to create accounts. The server 102 may execute the shared account service to provide a unified user interface (UI) to allow the user 108 to create an account on the service provider 104. The unified UI may also be used by user 108 to provide information to create other accounts in other service providers. The unified UI may consolidate common data fields provided by different service providers for account creation.

The shared account service may provide the unified UI through a portal to allow a client device 106 to render the unified UI. The unified UI may be rendered as a web application 110. The user 108 may interact with the web application 110 to provide description information of one or more accounts to be created in the service provider 104. The shared account service may analyze the description information with capability information from the service provider 104 to cause the service provider to create one or more accounts as provided by the description information.

While the example system in FIG. 1 has been described with specific components including a server 102 executing a shared account service that manages account creation for users of a tenant at one or more service providers, embodiments are not limited to these components or system configurations and can be implemented with other system configuration employing fewer or additional components. The approaches discussed here may be applied to any shared account service provided by an application and/or a server using the principles described herein.

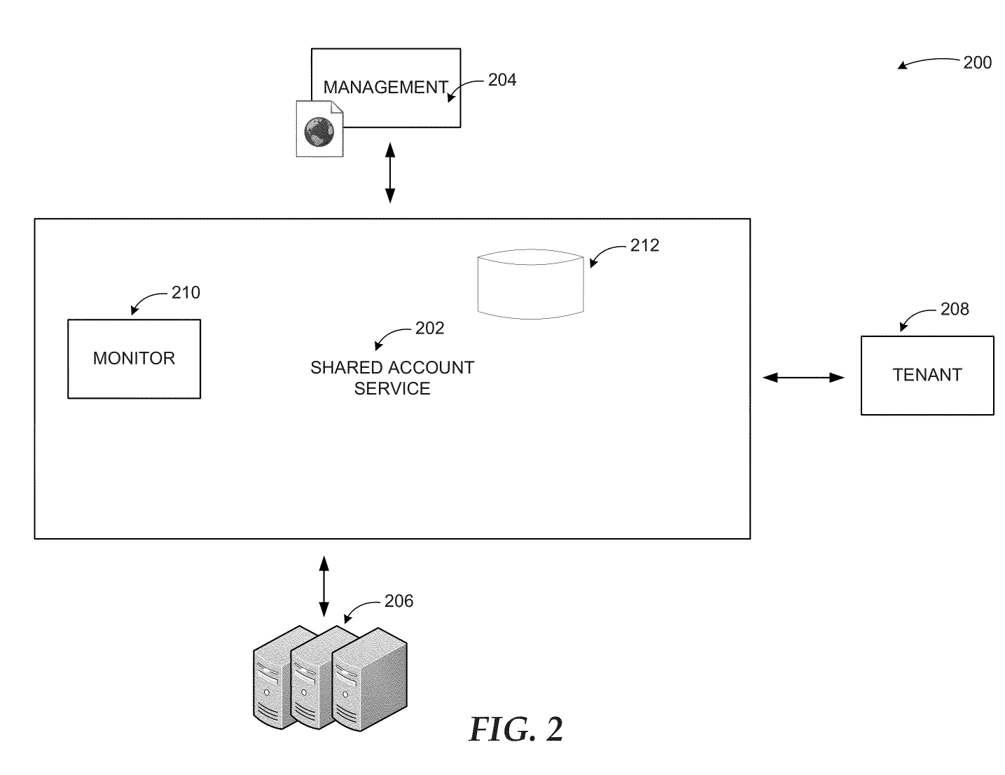

FIG. 2 is a component diagram of a shared account service managing account creation for users of a tenant at one or more service providers. Diagram 200 illustrates an example of a shared account service that manages account creation for users of the tenant 208.

The shared account service 202 may receive description information to create an account through a unified UI. The unified UI may be provided through a management portal 204. The management portal 204 may configure the unified UI for rendering at a client device (also known as a rendering source) based on rendering features (or capabilities) determined at the rendering source. In addition, the management portal 204 may manage security protocols to establish a secure communication with the client device. The client device may be an entity providing the description information of the account. Secure communication may be established through an authentication and an encryption of the secure communication. Furthermore, the management portal 204 may configure the unified UI based on a client application executing on the client device. In an example scenario, the management portal 204 may configure the unified UI to render as a web application for a client device that utilizes a web browser to connect to the shared account service 202 to allow a user to create an account at one or more service providers 206.

The shared account service 202 may receive the description information and analyze the description information. The service providers 206 may be queried to retrieve capability information. The capability information may describe resource availability at the service providers 206. Example of resources may include available storage space, available processing capacity, available memory capacity, and similar ones.

The shared account service 202 may analyze the description information with the capability information. The shared account service 202 may compare resources requested by the description information to available resources described by the capability information. In response to a determination of the available resources being sufficient to the requested resources, a contract may be configured by the shared account service. The contract may include instructions and actions to configure the service providers 206 to allocate resources for the account and to create the account. In addition, health of resources at the service providers 206 may be determined through a monitor service 210. The monitor service 210 may execute test scripts to determine viability of creating the account. Results may be stored in the data store 212. The data store 212 may be a local data store.

In addition, the monitor service 210 may be a component of the shared account service 202. Furthermore, the results of the executed test scripts may be analyzed to adjust the contract. The contract may be adjusted to create the account on the service providers 206 based on health of resources at the service providers 206. An example scenario may include a determination of a limited capacity for hard drive space at one of the service providers 206 as a result of the executed test scripts. In response to analysis of the result, the contract for creation of an account at the service provider may be adjusted to include an instruction to the service provider to re-organize a file system hosted in the hard drive space to free additional capacity to allow for creation of the account.

The contract may also include instructions to configure the tenant 208 for the account. The instructions may include creation of the tenant 208 in response to a determination of a lack of a tenant for the account, changing a status of the tenant 208 (i.e.: changing the status to an active status in response to determination that the tenant 208 had an inactive status), populating the tenant 208 with the account, and similar ones. Furthermore, the contract may be stored in the data store 212 to pre-configure the account. The contract may be stored at a local data store to pre-configure the account. The local data store may be an account data store. In response to detecting an access to the account, the contract may be transmitted to the service providers 206 to cause the service providers 206 to create the account. By pre-configuring the account, the shared account service may allow the service providers 206 to dedicate resources to active accounts and services. However, the shared account service 202 may continuously monitor health of resources at the service providers 206 through the monitor service 210 to adjust the contract for readiness to create the account in response to a detection to access the account by a user of the tenant 208.

Alternatively, the shared account service 202 may transmit the contract to the service providers 206 in response to receiving the description information from the management portal 204. The shared account service 202 may analyze the description information based on capability information received from the service providers 206 and configure the contact based on a result of the analysis. The capability information may be retrieved by the monitor service 210.

The examples of the shared account service 202 are not provided in a limiting sense. Other actions or services may be provided by the shared account service 202 to cause the service providers 206 to create an account.

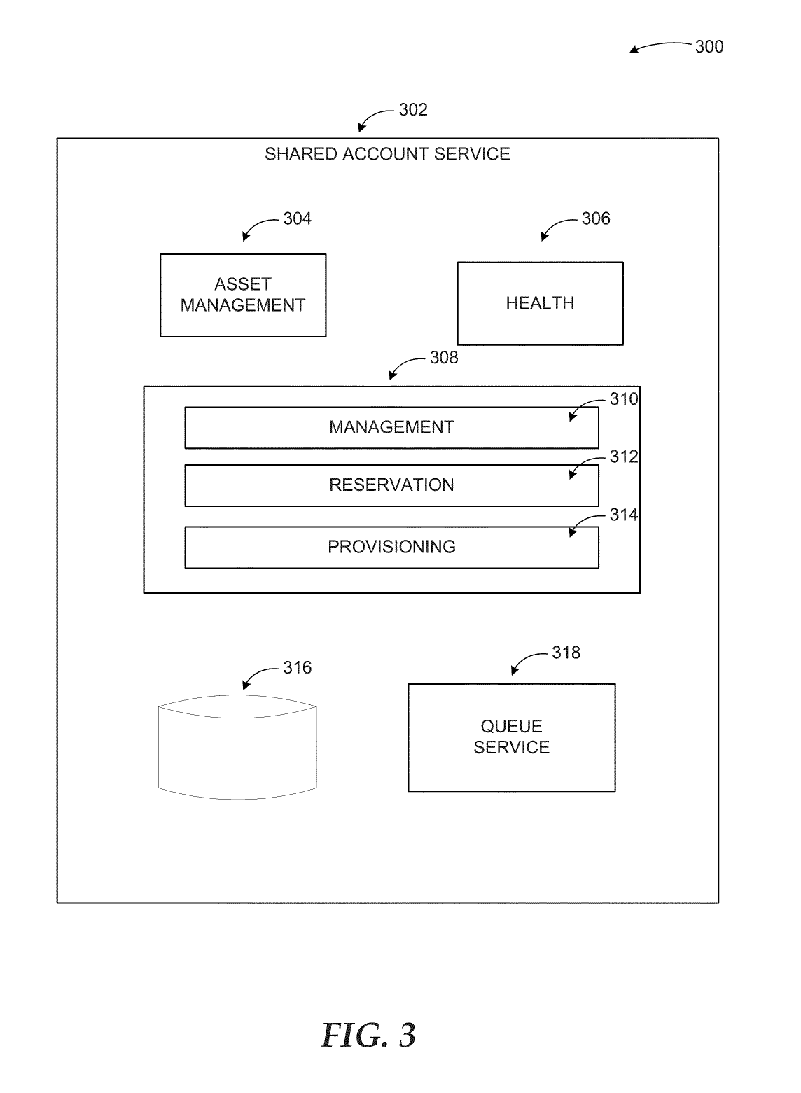

FIG. 3 illustrates an example shared account service and components, according to embodiments.

As shown in the diagram 300, the shared account service 302 may use an asset management service 304 to communicate with the unified UI rendered by the management portal service. The asset management service 304 may use a federation service to communicate with the unified UI. The asset management service may receive the description information for the account and instigate the health service 306 to query service providers associated with the description information. The health service 306 may query the service providers to retrieve capability information from the service providers. The capability information may be transmitted to core services 308 of the shared account service 302 by the health service 306. The description information may also be transmitted to core service 308 by the asset management service 304.

Management service 310 may execute analysis functions to analyze the description information with the capability information. The reservation service 312 may reserve resources at the service providers to allow the service providers to create the account. In addition, reservation service 312 may configure and save a contract that includes instructions and actions to create the account, at account data store 316. Health information associated with resources at the service providers may also be stored in the account data store 316 to save a state of the resources in a pre-configure process for creation of the account. Furthermore, the state and health of the account may also be stored in the account data store 316 by health service 306 that monitors the account.

Provisioning service 314 may manage placing of contracts for transmission to the service providers through the queue service 318. The queue service 318 may transmit the contracts to the service providers by loading the contract to a queue based data structure used for transmission to the service provider. The queue based data structure may be organized in a first in first out (FIFO) structure. Alternatively the queue based data structure may be organized in a last in first out (LIFO) structure. The core services of the shared account service may use certifications and federation service to confirm and authorize communication with other services of the shared account service or external entities such as the service providers. Queue service 318 may also use certifications and federation service to confirm and authorize communication with the service providers.

The example scenarios and schemas in FIGS. 2 and 3 are shown with specific components, data types, and configurations. Embodiments are not limited to systems according to these example configurations. Providing a shared account service may be implemented in configurations employing fewer or additional components in applications and user interfaces. Furthermore, the example schema and components shown in FIGS. 2 and 3 and their subcomponents may be implemented in a similar manner with other values using the principles described herein.

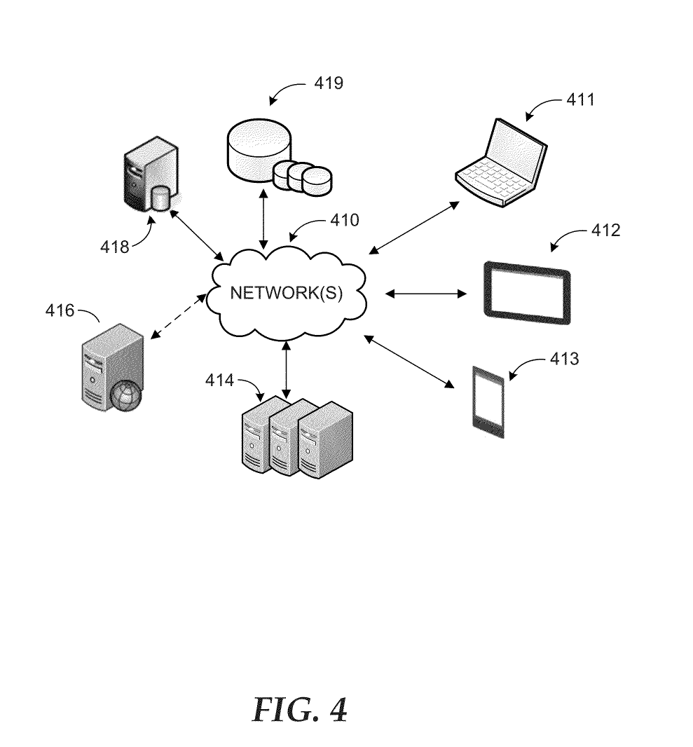

FIG. 4 is an example networked environment, where embodiments may be implemented. A system providing a shared account service may be implemented via software executed over one or more servers 414 such as a hosted service. The platform may communicate with client applications on individual computing devices such as a smart phone 413, a laptop computer 412, or desktop computer 411 (‘client devices’) through network(s) 410.

Client applications executed on any of the client devices 411-413 may facilitate communications via application(s) executed by servers 414, or on individual server 416. The shared account service may receive description information of an account from a provided unified UI. The description information may be analyzed with retrieved capability information of service providers. A contract may be generated based on a result of the analysis. The contract and health monitoring data of accounts and resources at the service providers may be stored in data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to provide a shared account service. Furthermore, the networked environments discussed in FIG. 4 are for illustration purposes only. Embodiments are not limited to the example applications, modules, or processes.

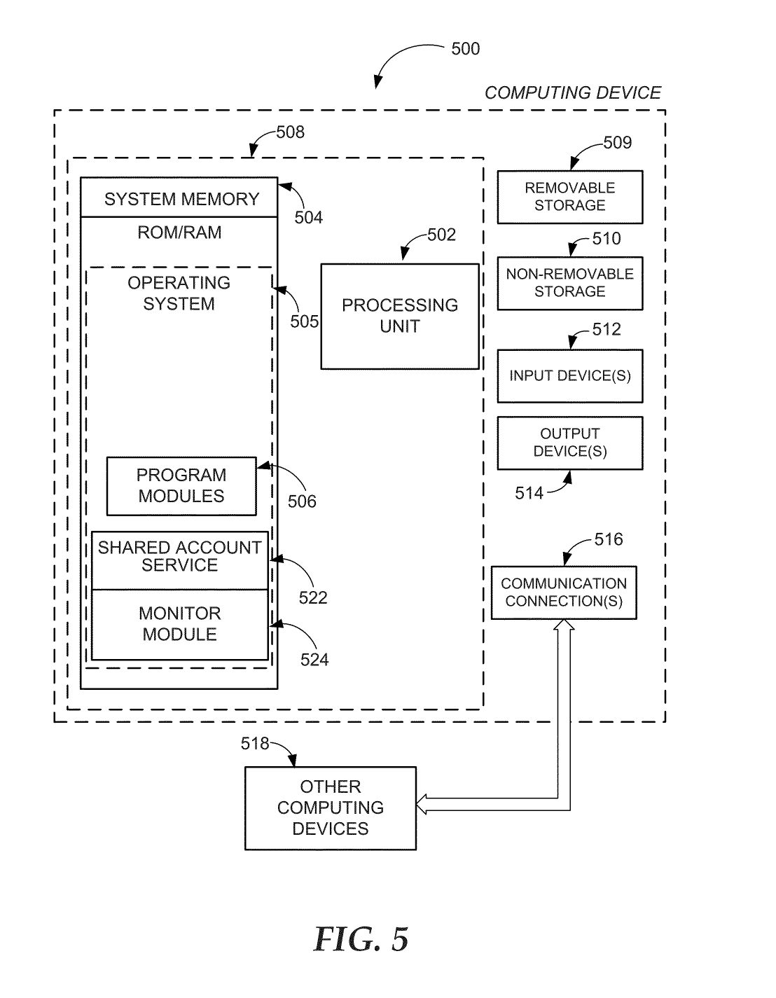

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing applications of a shared account service according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, a shared account service 522, and a monitor module 524.

The shared account service 522 in conjunction with the monitor module 524 may provide a shared account service through the computing device 500. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

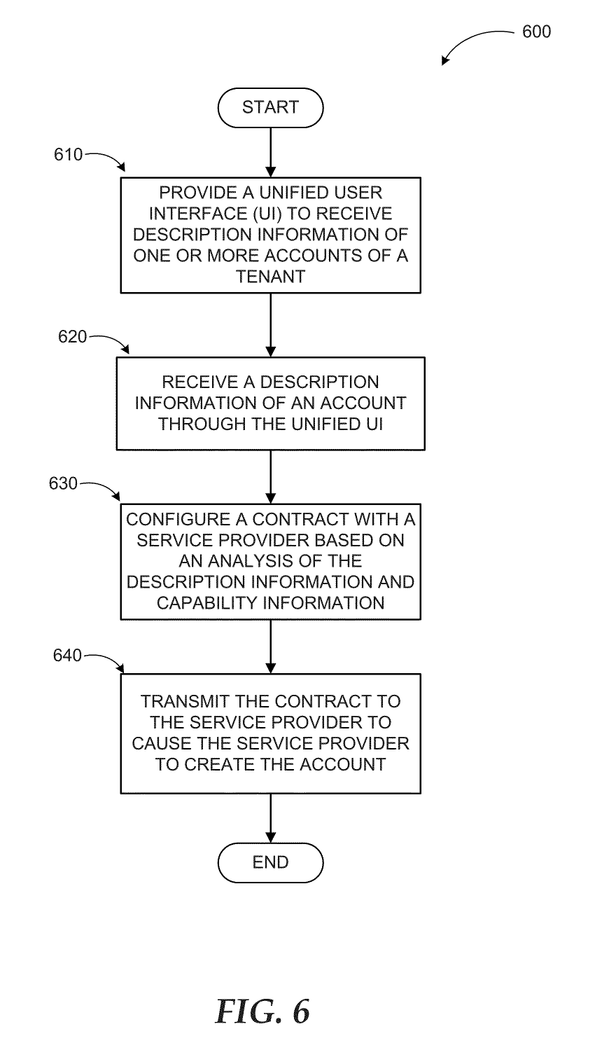

FIG. 6 illustrates a logic flow diagram for a process to utilize interactivity signals to generate relationships and promote content according to embodiments. Process 600 may be implemented through a shared account service.

Process 600 begins with operation 610 providing a unified user interface (UI) to receive a description information of one or more accounts of a tenant. The unified UI may provide consolidated account fields of one or more service providers. A description information of an account may be received through the unified UI at operation 620. A contract may be configured with a service provider based on an analysis of the description information and a capability information. The service provider may be determined from the description information. The capability information may be retrieved from the service provider. Next, at operation 640, the contract may be transmitted to the service provider to cause the service provider to create the account.

According to some embodiments, a method may be provided to provide a shared account service. An example method may include providing a unified user interface (UI) to receive description information of one or more accounts of a tenant, receiving a description information of an account through the unified UI, configuring a contract with a service provider based on an analysis of the description information and a capability information, and transmitting the contract to the service provider to cause the service provider to create the account.

According to other embodiments, the method may include providing the unified UI that consolidates one or more account creation data fields that are provided by the service provider and other service providers. The unified UI may be configured based on rendering features determined at a rendering source. The service provider may be determined from the description information, and the service provider may be queried to retrieve the capability information. In addition, the capability information may be determined to include information of one or more resources, where the one or more resources include one or more from a set of: an available storage space, an available processing capacity, and available memory capacity.

According to further embodiments, the method may include one or more instructions and one or more actions in the contract to cause the service provider to create the account. One or more requested resources described by the description information may be compared to one or more available resources described by the capability information to determine the one or more available resources to be sufficient to the one or more requested resources. The contract may be adjusted based on a determination of a health of one or more resources described by the capability information.

According to some embodiments, the method may include pre-configuring the account to cause the service provider to dedicate one or more resources described by the description information, storing the contract at a local data store, monitoring health of the one or more resources at the service provider, adjusting the contract based on the health of the one or more resources, and transmitting the contract to the service provider in response to a detection of an access to the account. Security protocols may be managed to establish a secure communication with an entity providing the description information. The secure communication may be established through an authentication and an encryption of the secure communication.

According to some embodiments, a server may be provided to provide a shared account service. The server may include a memory, a processor coupled to the memory. The processor may execute the shared account service in conjunction with instructions stored in the memory. The shared account service may be configured to provide a unified user interface (UI) to receive description information of one or more accounts of a tenant, where the unified UI consolidates one or more account creation data fields that are provided by the service provider and other service providers, receive a description information of an account through the unified UI, configure a contract with a service provider based on an analysis of the description information and a capability information, and transmit the contract to the service provider to cause the service provider to create the account.

According to other embodiments, the shared account service may be further configured to include one or more instructions from a set of: create the tenant in response to a determination of a lack of the tenant, change a status of the tenant, where the status includes an inactive status or an active status, and populate the tenant with the account in the contract. One or more resources described by the description information may be reserved in response to a determination of an availability of the one or more resources from the capability information that is retrieved from the service provider. Health information associated with one or more resources described by the description information may be stored in an account data store to pre-configure the account for creation, where the health information is queried from the service provider. The contract may be provisioned through a process to place the contract in a queue service for transmission to the service provider. One or more certificates and one or more federation services may be utilized to confirm and authorize one or more communications with the service provider to cause the service provider to create the account.

According to some embodiments, a computer-readable memory device may be provided to provide a shared account service. The instructions may cause a method to be performed in response to execution, the method being similar to the methods described above.

The operations included in process 600 are for illustration purposes. A shared account service may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide a shared account service, the method comprising:
providing a unified user interface (UI) to receive a description information of one or more accounts of a tenant;
receiving the description information of an account through the unified UI;
configuring a contract with a service provider based on an analysis of the description information and a capability information; and
transmitting the contract to the service provider to cause the service provider to create the account.

2. The method of claim 1, wherein providing the unified UI comprises:
enabling consolidation of one or more account creation data fields that are provided by the service provider and other service providers on the unified UI.

3. The method of claim 1, further comprising:
configuring the unified UI based on rendering features determined at a rendering source.

4. The method of claim 1, further comprising:
determining the service provider from the description information; and
querying the service provider to retrieve the capability information.

5. The method of claim 1, further comprising:
determining the capability information to include information of one or more resources, wherein the one or more resources include one or more from a set of: an available storage space, an available processing capacity, and available memory capacity.

6. The method of claim 1, further comprising:
including one or more instructions and one or more actions in the contract to cause the service provider to create the account.

7. The method of claim 1, further comprising:
comparing one or more requested resources included in the description information to one or more available resources included in the capability information to determine the one or more available resources to be sufficient to the one or more requested resources.

8. The method of claim 1, further comprising:
adjusting the contract based on a determination of a health of one or more resources included in the capability information.

9. The method of claim 1, further comprising:
pre-configuring the account to cause the service provider to dedicate one or more resources included in the description information;
storing the contract at a local data store;
monitoring health of the one or more resources at the service provider;
adjusting the contract based on the health of the one or more resources; and
transmitting the contract to the service provider in response to a detection of an access to the account.

10. The method of claim 1, further comprising:
managing a security protocol to establish a secure communication with an entity providing the description information.

11. The method of claim 10, further comprising:
establishing the secure communication through an authentication and an encryption of the secure communication.

12. A server to provide a shared account service, the computing device comprising:
a memory;
a processor coupled to the memory, the processor executing the shared account service in conjunction with instructions stored in the memory, wherein the shared account service is configured to:
provide a unified user interface (UI) to receive description information of one or more accounts of a tenant, wherein the unified UI consolidates one or more account creation data fields that are provided by the service provider and other service providers;
receive the description information of an account through the unified UI;
configure a contract with a service provider based on an analysis of the description information and a capability information; and
transmit the contract to the service provider to cause the service provider to create the account.

13. The computing device of claim 12, wherein the shared account service is further configured to:
include one or more instructions from a set of:
create the tenant in response to a determination of a lack of the tenant,
change a status of the tenant, wherein the status includes an inactive status or an active status, and
populate the tenant with the account,
in the contract.

14. The computing device of claim 12, wherein the shared account service is further configured to:
reserve one or more resources included in the description information in response to a determination of an availability of the one or more resources from the capability information that is retrieved from the service provider.

15. The computing device of claim 12, wherein the shared account service is further configured to:
store health information associated with one or more resources included in the description information in an account data store to pre-configure the account for creation, wherein the health information is queried from the service provider.

16. The computing device of claim 12, wherein the shared account service is further configured to:
place the contract in a queue service for transmission to the service provider.

17. The computing device of claim 12, wherein the shared account service is further configured to:
utilize one or more certificates and one or more federation services to confirm and authorize one or more communications with the service provider to cause the service provider to create the account.

18. A computer-readable memory device with instructions stored thereon to provide a shared account service, the instructions comprising:
providing a unified user interface (UI) to receive a description information of one or more accounts of a tenant, wherein the unified UI consolidates one or more account creation data fields provided by the service provider and other service providers;
receiving a description information of an account through the unified UI;
determining a service provider from the description information;
querying the service provider to retrieve a capability information;
configuring a contract with the service provider based on an analysis of the description information and the capability information; and
transmitting the contract to the service provider to cause the service provider to create the account.

19. The computer-readable memory device of claim 18, wherein the instructions further comprise:
comparing one or more requested resources included in the description information to one or more available resources included in the capability information to determine the one or more available resources to be sufficient to the one or more requested resources; and
adjusting the contract based on a determination of a health of the one or more available resources.

20. The computer-readable memory device of claim 18, wherein the instructions further comprise:
pre-configuring the account to cause the service provider to dedicate one or more resources included in the description information;
storing the contract at an account data store;
monitoring health of the one or more resources at the service provider;
storing health information associated with the one or more resources described in the account data store to pre-configure the account for creation, wherein the health information is queried from the service provider;
adjusting the contract based on the health of the one or more resources; and
transmitting the contract to the service provider in response to a detection of an access to the account.
